(19) United States
(12) Patent Application Publication
(10) Pub. No.: US 2009/0324799 A1
(43) Pub. Date: Dec. 31, 2009

(54) MAXIMIZING UTILIZATION OF MUNICIPAL SEWAGE TREATMENT EFFLUENTS TO PRODUCE A BIOFUEL, FERTILIZER AND/OR ANIMAL FEED FOR ENVIRONMENTALLY SUSTAINABLE MINDED COMMUNITIES

(76) Inventors: Robert Michael Hartman, Ponte Vedra Beach, FL (US); Henry Brockenton Thomas, Jacksonville, FL (US); Dale Anthony Casamatta, Jacksonville Beach, FL (US); Walter Pendley Bussells, Jacksonville, FL (US); Leo Hartman, Fern Park, FL (US)

Correspondence Address: MICHAEL RIES, 318 PARKER PLACE, OSWEGO, IL, 60543, US

(21) Appl. No.: 12/466,299

(22) Filed: May 14, 2009

Related U.S. Application Data
(60) Provisional application No. 61/053,542, filed on May 15, 2008.

(51) Int. Cl. A23K 1/00; C05F 3/00; C10L 1/188

(52) U.S. Cl. 426/635; 71/12; 44/307

(57) ABSTRACT

Continuously produced algae is seeded into the waste streams by the use of 4 or more photo bio-reactors. The algae so produced manufacture oils and fats inside their cells from nutrients in the waste and the process of photosynthesis. Their growth is enhanced by the use of screens, both fixed and movable. These algae adhere to the screens or to the long chain algae attached there to. Algae removed from the raceway bio-reactor are killed by repeated application of heavy rollers over leveled out extracted algae cells. The dead algae are covered with recycled process waste water which goes to one of more oil/water separators and then to storage tanks that contain bio-diesel oil fraction, to waste water tanks and to storage bins for solid waste dead cell material removed.

### REFERENCE TO RELATED APPLICATION

This patent application claims the benefit of U.S. Provisional Application No. 61053542 filed on May 15, 2008, the disclosure of which is incorporated herein in its entirety by reference.

### BACKGROUND OF THE INVENTION

1. Field of the Invention

The present invention relates generally to a system for treating municipal sewage treatment plant inputs to lower the discharge of nutrients from those plants to the environment. This is accomplished by using nutrients in the incoming sewage to commercially grow large quantities of specific algae strains to produce bio-diesel in a specially designed process. Oils contained in the cells of mature algae can be extracted and sold as bio-diesel fuel. Other useful byproducts can then be made from the cell residue that remains.

This accomplishes two important goals: 1) certain man-made water and air pollutants to the environment are significantly reduced, 2) production of bio-diesel is sustainably produced, lowering our dependence on foreign oil sources while diversifying the base of combustion fuel sources and producing fertilize and animal and fish feed byproducts. All this is accomplished without competing with the supply of any food crop.

2. Description of Related Art

Most municipal sewage treatment plants in the United States use a combined primary and secondary waste treatment process. The primary part of the process removes solid waste and oil and grease coming into such plants. The secondary part uses aeration coupled with microbial action and sludge removal to remove most of the bacterial organisms and organic solids in the remaining sewage. Such processes often uses surface-aeration sedimentation basins to achieve 80 to 90% removal of Biological Oxygen Demand with retention times up to 10 days. The useful bacteria in these basins significantly reduce harmful bacteria. The sludges that form in these sedimentation basins commonly are run through clarifers and the sludges that form at the bottom are pumped to a sludge digestor. The purpose of sludge digestion is to reduce the amount of sludge formed organic matter and the number of disease-causing microorganisms present in the sludge. The most common sludge treatment options include anaeorbic and aerobic digestion.

However, treating municipal sewage in the combined primary and secondary waste treatment processes, does not significantly remove liquid nutrients such as nitrogen and phosphorous in the incoming sewage. Typically the concentration of nitrogen in the water discharge from such plants are around 12 mg/L while that in the primary settling basins are around 30 mg/L. Unfortunately these elevated levels of nutrients are high enough to stimulate a destructive biological process called eutrophication. Eutrophication happens with warm water temperatures, high nutrient levels, lots of sunshine and calm waters. This destructive biological process robs oxygen from the water killing some fish species and covers submerged aquatic plants living in shallow waters. These changes are harmful to aquatic organisms in natural water bodies. What is needed is a process that decreases nitrogen and phosphorous in sewage liquid effluents by around 25-45% and can accomplishe this while producing bio-diesel which, as indicated above, lowers our dependence on foreign oil sources and diversifies our mix of combustion fuels.

### SUMMARY OF THE INVENTION

In an embodiment of the invention a method and process for quickly growing and separating certain strains of algae is disclosed. These algae produce oils and fats inside their cells which are chemically similar to diesel oil. The algal metabolic processes produces oils, while utilizing nitrogen and phosphorous in the liquid municipal sewage; The algae's metabolism processes producing these oils and fats take up nitrogen and phosphorous in the liquid municipal sewage effluent. As the algae cells mature and are killed their cell walls weaken giving the opportunity to squeeze out the oils and fats from the dead cells. The remaining biomass can then be used as fertilizer and/or animal feed.

To accomplish these results, an embodiment comprising the following equipment and/or components is disclosed:
addition of a possible clarifier/aeration tank for further treatment of digester and sedimentation basin sludge at the sewage treatment plant prior to sending any of those waste streams to the three phase algae growing, separation and oil extraction process;
a nutrient recycle tank to receive, hold and re-inject process waste water high in nitrogen and phosphorus concentration;
a surge tank that receives and stores waste streams from the sewage treatment plant that when directed allows those waste streams the missing tank and bio-reactor # 1;
a storage tank that receives and stores high nutrient waste streams from other compatible sources such as animal waste that are off site from the sewage treatment plant;
from 2-5 algae seed tanks to store and when directed inoculate algae into the mixing tank and bio-reactor # 1.

In open loop bio-reactor # 1 algae strains are inoculated and mixed into the waste streams causing growth to begin. Some of these algae strains produce long filamentous chains of algae that tend to link together and float at the top of the tanks where they can be raked together and sluiced off. The filamentous algae also become attachment places for smaller non-chain forming algae to adhere. Other smaller algae forms tend to form clumps that fall to the bottom of tanks or other liquid containing vessels allowing these clumps to be drained off.

The main place for growing and separating mature algae from the process occurs in a large oval, race track shaped bio-reactor. That open bio-reactor (# 2), receives several inputs from algal growing streams that are being recycled to allow more time for the algae in such streams to grow. This race track has several fixed and one traveling screen that both provide a platform for algae to adhere to and grow making it easier for the algae to be removed. The race track also has piping to allow inputting ambient air or combustion gases that are high in carbon dioxide and oxygen plus other nutrients such as methane.

The algal sludge storage tank has a translucent top that allows sunlight to facilitate algal growth while that sludge waits its turn to go through bio-reactors # 3 and # 4. A smaller bio-reactor feed tank with a translucent top acts like a surge tank for bio-reactors # 3 & 4.

The two closed loop bio-reactors (# 3 & 4) continue to grow algae from the sludge drain line of bio-reactor # 1 and the algal sludge storage and surge tanks before injecting their supply of algae in the race track.

Two moist algal sludge and strand storage bins allow older maturing algal cells separated from bio-reactor # 2 to be collected and begin to dry out. Operating one at a time, each bin collects, drains off fluid and smoothes out the drying mature algae along the floor of the bins. The more mature algae cells become weaken allowing for the algal cell walls to be opened when run-over by heavy rollers. These bins are constructed like shallow swimming pools that allow recycled water to come in to barely cover the smoothed out clumps and strands of algae as they accumulate on the floor.

Each bin has floor drains with attached sumps that collect water and oils that drain away as the algae are squeezed by the heavy rollers. This flooding and rolling process is repeated several times to capture all the oils and fats in the algae cells.
Fluids in the floor drain sumps are drained to one or more oil/water separators,
storage tanks for the oil and nutrient water being separated are supplied, and
a dry storage bin for the dead cell debris collected for reuse off site is supplied.

The foregoing has outlined, rather broadly, the preferred equipment and component features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a schematic illustration of the overall set up of equipment for the first step of the claimed process;

FIG. 2 is a schematic illustration of a set up of equipment for conducting a second step of the claimed process; and

FIG. 3 is a schematic illustration of a set up of equipment for conducting a third step of the claimed process.

### DETAILED DESCRIPTION OF THE INVENTION

The invention disclosed converts certain primary and secondary sewage treatment plant side streams and effluents into bio-diesel fuels, fertilizer and animal feed and, at the same time, solves the problem of emitting nitrogen, and phosphorous in the water effluents from the sewage treatment facility. In the invention, algae is injected into a mixture of sewage effluent streams which causes the algae to grow rapidly in a carefully selected and designed set of four or more photo bio reactors. These are carried out under carefully controlled conditions of temperature, light, flow rate, levels of nutrients and use of recycled water. The algae cells are collected at preset times and the oils and fats in the algae cells are pressed out by mechanical means and collected in a storage tank for use as a bio-diesel fuel in place of refined oils.

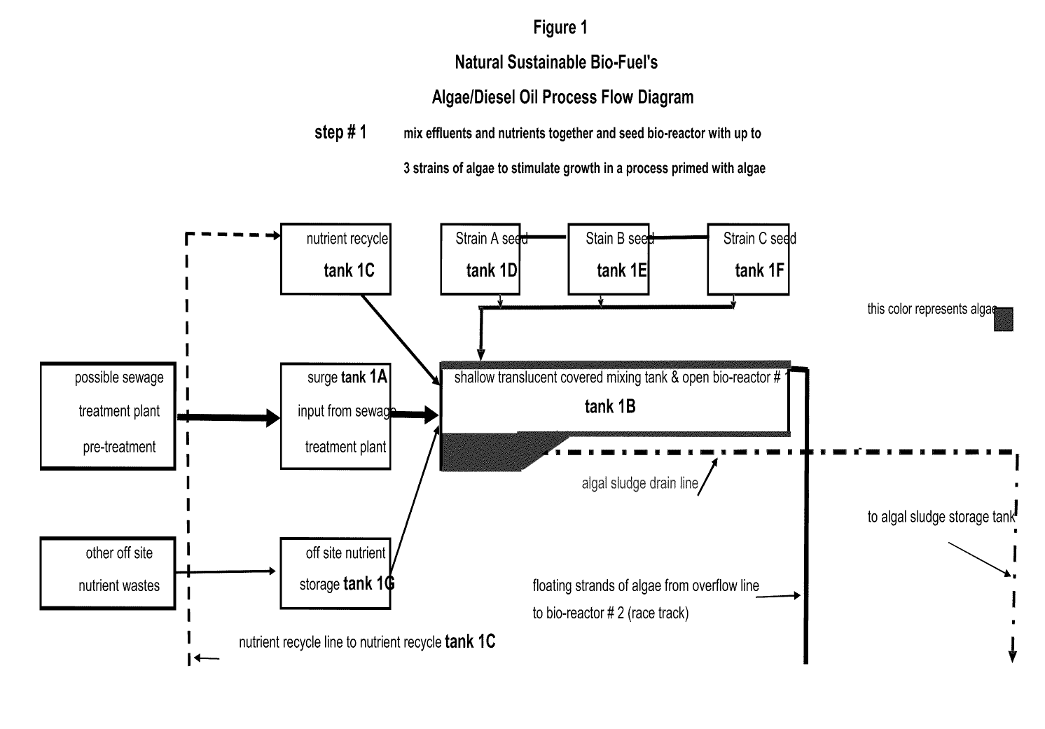

Referring to FIG. 1, selected sewage streams are fed through a pipe from the sewage treatment plant to a receiving surge tank 1A in the algae/diesel oil production facility. Note that any waste streams from the sewage treatment plant exiting any sedimentation basin in that plant (such as from the sewage treatment plant's sludge digesters) high in organic sludge may require pretreatment before sending it to this algae/diesel oil production facility. That is because such sludge interferes with light penetration and increases the risk of small protozoan animals being introduced that can eat the needed algae. If this is the case, a small clarifier/aerator will be added at the sewage treatment plant to remove that sludge.

Note that in a prior art system, the main input liquid waste from a combined primary and secondary sewage effluent ordinarily goes to a natural water body which results In increasing the level of nutrient pollutants in that water body.

In this invention the selected sewage streams enters the mixing tank 1B which has a shallow but relatively large surface. This mixing tank is open to the atmosphere and the output of the mixing tank is fed to bio-reactor # 2 and to algal sludge storage tank 2A. This allows sunlight to enter continuing the photosynthesis begun in tank 1B. This tank is also referred to as bio-reactor # 1.

Note that if more nutrient rich water is needed in tank 1A for the process, that water can be obtained from the nutrient recycle tank 1C. Note also that if more nutrient is needed from off site nutrient rich sources, such input can be obtained from tank 1G Different algae from different algal seed tanks 1D, 1E and 1F can be added, either together or separately, to accelerate the growth of algae in the algae/diesel oil production facility here disclosed. If more algae are needed these can be added at any time. Note that this whole process is normally in constant movement. This means that referring to some part as the beginning of the process does not literally mean that since there is constant re-supply and re-withdrawal occurring. Thus, as more liquid waste is added to tank 1B, more algae growth continues in bio-reactor # 1 and more algae sludge continues to be formed in the bottom of tank 1B. A small amount of floatable algae strands may begin to appear at the surface of bio-reactor # 1. Those strands can be raked off and added to the algae in the storage bins 3A and 3B. Any overflow liquids from this 1^{st} bio-reactor will go to bio-reactor # 2.

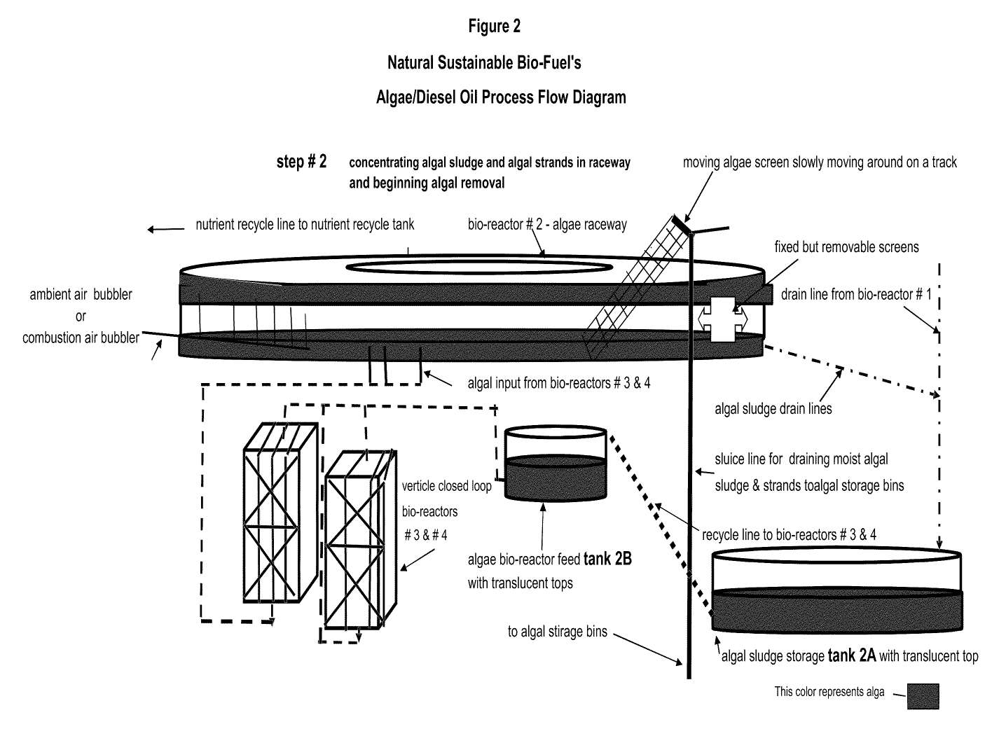

Referring to FIG. 2, bio-reactor # 2 is the step in the process where most of the algae are produced. This bio-reactor has a surface area and depth that is a function of the volume of the waste streams it is designed to handle. Also it needs to be deep and should store at least 4 days worth of algal sludge that accumulates in the bottom of the raceway. However, the raceway should not prevent sunlight from penetrating down at least 2 feet. To aid in removing algae from the raceway two types of screens are provided. One type is a fixed horizontally and/or vertically placed screen that can be easily removed to rake off the algae that accumulates. The other is a diagonally placed traveling screen as shown in FIG. 2. This traveling screen moves slowly around the raceway on tracks taking about 1-4 days to make one trip around. The speed of travel depends on the length of the raceway and the volume of sewage being processed through the process.

Fresh ambient air containing oxygen and carbon dioxide is bubbled through the raceway at several points at the bottom of that raceway (see FIG. 2) to further promote good algae growth. If need be, combustion flue gases containing higher levels of carbon dioxide can be added in place of ambient air.

More nutrient rich algal input is added to the raceway from closed loop bio-reactors # 3 and # 4 as indicated in FIG. 2. The main inputs to these two bioreactors lined up in series comes from the algal sludge storage tank 2A which contains a substantial amount of immature and rapidly multiplying algae that needs to be grown out. This liquid, which is recycled for further growth, is first pumped to the algal bio-reactor feed tank 2 B which is at a slightly higher head compared to the head of bio-reactors # 3 and # 4. By recycling and lining these two bio-reactors up will enhance the growing time and thus the amount of oil being produced by the algae.

This step in the process begins the more significant part of algae separation of the more mature algae cells from the process liquids. This algae separation is accomplished by employing two types of screens. One type is a slow but continuously moving traveling screen inclined at an angle that may vary from between 30 degrees to 70 degrees. This traveling screen moves around the circular raceway track (see FIG. 2). As this screen moves, it picks up algal clumps and strands from the bottom to the top of the fluid in the raceway and directs the formed algae slumps and strands out of the raceway water. The water drains off the back of the traveling screen as this screen slowly rises out of the water. Moist clumps and strands of algae are then either raked off or blown off into a conveyor or sluiceway that moves the material to an open top moist algal storage bin where it goes through a further process.

As also indicated previously, smaller fixed horizontal and vertical screens are provided at several locations round the raceway. These are small enough and the raceway shallow enough that they can be manually removed as these screens become filled and before the very slow moving screen comes to any location where the fixed screens are located. The algae on these fixed manually removed screens will be either sluiced to or manually transported to algae storage bins 3A and 3B.

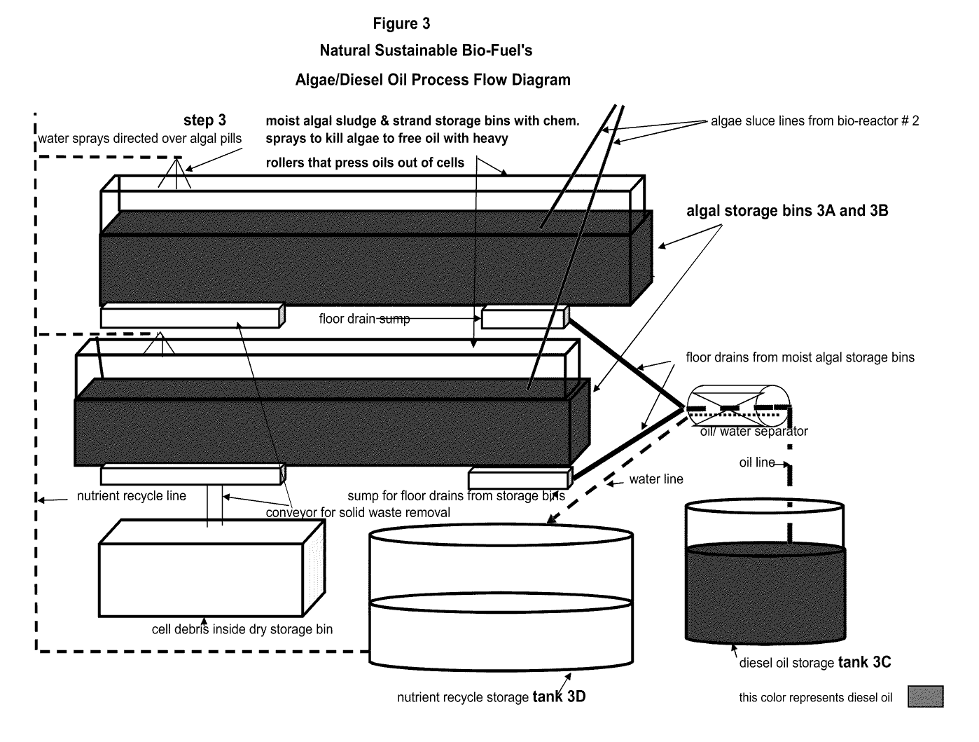

As the algae is recycled around the raceway (bio-reactor # 2), it multiplies and grows. At the same time, more and more of the algae are separated out of the raceway and conveyed to the open top moist algae strands storage bins 3A and 3B as shown in FIG. 3. The two algal storage bins are constructed such that as a bin becomes half full, it can be separated from the line while its contents are processed as described below. The new bin is then brought on line and fills with algae, and the process described below is repeated.

Referring to FIG. 3, as each of bins 3A and 3B are being filled and stored in the storage bins (3A and 3B) they are leveled out. When each bin is about half full, a heavy compacting roller (not shown) is run over the top of the algal cells in the bin crushing the oil and fatty acids out of the destroyed algae cell walls.

Water is then applied either from floor drain sumps or from the nearby nutrient recycle line (FIG. 3) to barely cover the rolled material until it almost reaches the top of the rolled material and the material is rolled again. The water is then drained off to a sump and from there to an oil/water separator (see FIG. 3) that separates the oil and water from the water being drained out of the storage bins. The oil fraction from the separator goes to oil storage tank 3C and the water fraction is fed to a nutrient water storage tank 3D to be recycled back through the whole system or sent back to the sewage treatment plants effluent.

This process of heavy rolling followed by water flushing and water draining through an oil water separator is repeated several times until no significant evidence of additional oil in the drainage from the bin is found. At the end of the process the dead cell debris is removed and placed in a solids debris bin 3E (FIG. 3) for off site use as a fertilizer and/or fish feed.

In an embodiment of the invention, an ultra sound system might be used to open the algae cell walls if the sprays or UV light is found not to work well. Currently ultra sound is not well proven to separate oil in the dead cell in the algae storage bins.

While there have been shown and described fundamental novel features of the invention as applied to the preferred embodiments, it needs to be understood that various omissions and substitutions and changes of the form and details of the apparatus illustrated and in the operation may be done by those skilled in the art, without departing from the spirit of the invention.

What is claimed is:

1. A process that is able to accept waste streams from various types of combined primary and secondary type sewage treatment facilities comprises: growing algae which produce oils and fats inside their cells which are chemically similar to diesel oil; crushing said algae to squeeze out the oils and fats from the cells; and collecting the dead algae for use as fertilizer and/or animal feed.

2. The process of claim 1 wherein clarifiers are used to remove excess levels of organic sludge that may clog up and make light penetration into the streams more difficult before certain sewage waste streams are sent to the algae growing part of the process.

3. The process of claim 2 wherein four bio-reactors are used for rapidly growing algae; and coupled to using extraction means to reliably and cost effectively remove the produced algae and the oils in the cells of those algae.

4. The process of claim 3 wherein the algae is grown in a bio-reactor having a raceway that promotes recycling of nutrients and allows time for more algae growth to occur.

5. The process of claim 4 wherein said raceway is coupled to either receive ambient air or carbon dioxide in combustion flue gases which is bubbled through the fluids in said raceway.

6. The process of claim 5 wherein said raceway of said bio-reactor includes two types of screens where algae can attach and grow on as well as for separating and removing mature algal sludge slumps and strands from said raceway.

7. The process of claim 6 wherein one of said two types of screens is slowly driven along the raceway to move algae from the bottom of the raceway to the top and then out of liquid in the raceway at an incline of 30 to 70 degrees so algae can drain excess fluids before the removed algae are transferred to an algae storage bin.

8. The process of claim 7 wherein the top of said bio-reactors as well as other tanks have translucent tops to receive sun light so that photosynthesis can continue the algae growth process.

9. The process of claim 8 further comprising seeding different strains of algae into any incoming stream of wastes to obtain a best proportion and mix of algae strains for those waste streams.

10. The process of claim 9 wherein the sewage waste streams are continuously received and processed for obtaining a bio-diesel fuel and fertilizer and/or animal feed.

11. A method of obtaining diesel oil and fertilizer and/or animal feed from waste streams fed to a bio-reactor for processing wherein said bio-reactor has a raceway.

12. The method of claim 11 wherein said bio-reactor is coupled to receive either ambient air containing oxygen or combustion flue gases containing carbon dioxide which is bubbled through the mixture in said bio-reactor thereby reducing the carbon dioxide in said combustion flue gases and adding more nutrients for algae growth.

13. The method of claim 12 wherein said air containing carbon dioxide is injected at the bottom of the raceway in said bio-reactor.

14. The method of claim 13 wherein said bio-reactor includes one continuously moving screen and several fixed but easily removable screens for picking up algal slumps and strands of algae located in said bio-reactor.

15. The method of claim 14 wherein said traveling screen continuously moves on tracks along a circular inclined path in said bio-reactor.

16. The method of claim 15 wherein said traveling screen can be adjusted to incline at an angle of between 30 degrees and 70 degrees.

17. The method of claim 16 wherein moist algae is transferred to and stored in one of two storage bins that receive water for flooding rolled algae and with UV lights to further aid in killing rolled algae in said bins.

18. The method of claim 17 wherein algal cells are compressed by heavy rollers to destroy the algae cell walls to release the oils and fats inside the cells of said algae.

19. The method of claim 18 wherein the compressed algae in said bins are flooded with recycled water.

20. The method of claim 19 wherein the flooded and compressed algae are sent to oil/water separators to separate the oils and fats and the water fraction from each other.
